(19) United States
(12) Patent Application Publication
(10) Pub. No.: US 2008/0309532 A1
(43) Pub. Date: Dec. 18, 2008

(54) Solid-state imaging device and method of manufacturing thereof

(75) Inventor: Min Che Lin, Hsinchu (TW)

Correspondence Address: BIRCH STEWART KOLASCH & BIRCH, PO BOX 747, FALLS CHURCH, VA, 22040-0747, US

(73) Assignee: Silicon Optronics, Inc.

(21) Appl. No.: 11/808,669

(22) Filed: Jun. 12, 2007

(51) Int. Cl. H03M 1/66; H03M 1/12

(52) U.S. Cl. 341/137

(57) ABSTRACT

The invention provides a solid-state image sensor comprising a pixel array, a reading circuit, an analog-to-digital (A/D) circuit, a decoding circuit, a driving circuit, a power array, a spare circuit, a fuse array, and a repair unit. When one described element fails, a repair procedure is applied to select a corresponding element from the spare circuit to replace the failed element via the fuse array.

### BACKGROUND OF THE INVENTION

1. Field of the Invention

The invention relates to a solid-state image sensor, and more particularly to a solid-state image sensor providing a fast repair mechanism.

2. Description of the Related Art

In electronic devices comprising a pixel array, such as CMOS sensors, liquid crystal displays or plasma displays, display or sensor errors occur when pixels in the array fail, such as when dead pixels occur. Display and sensor data are real-time and positional, thus, dead pixels cannot be substituted directly like dead memory cells replaced by redundant memory cells. Typically, a few failed Sensor pixels can be corrected by software. For example, when one pixel fails in a CMOS sensor and cannot receive the sensor data from the dead pixel, the software can simulate the pixel value of the dead pixel based the pixel values of the pixels adjacent to the dead pixel. Software, however, cannot repair an entire column of dead pixels. Normally, the probability of a column of pixels failing is under control based on present process techniques. The possible cause of a dead pixel or a column of dead pixels is not the pixels themselves, but mostly be due to a failed driving circuit, decoding circuit, power line or ground line.

### BRIEF SUMMARY OF THE INVENTION

The invention provides a solid-state image sensor and a rapidly repair procedure to repair the dead pixels in the solid-state image sensor.

The invention provides a solid-state image sensor, comprising a pixel array, a reading circuit, an analog-to-digital (A/D) circuit, a decoding circuit, a driving circuit, a power array, a spare circuit, a fuse array, and a repair unit. The pixel array has a plurality of column pixels and row pixels. The reading circuit has a plurality of reading units. The analog-to-digital circuit has one or a plurality of A/D converters. The decoding circuit disposed in one side of the pixel array receives or generates an address to select one or a plurality of column pixels or row pixels. The driving circuit has a plurality of driving units for driving the selected column pixels or row pixels. The power array has a plurality of power lines and ground lines, wherein each column pixel is coupled to one power line and one ground line. The spare circuit has a spare driving circuit, a spare decoding circuit, a spare reading circuit, a plurality of spare power lines and ground lines. When the reading circuit, the analog-to-digital circuit, the decoding circuit, the driving circuit, the power line or the ground line coupled by the selected column pixel or row pixel fails, a repair procedure is applied to select the spare driving circuit, the spare decoding circuit, the spare reading circuit, the spare power line or the ground line to replace the fail one via the fuse array.

The invention provides an image display device comprising a pixel array, a power array, a decoding circuit, a digital-to-analog (D/A) converting and driving circuit, a spare circuit, a spare power line array, a fuse array, and a repair unit. The pixel array has a plurality of column pixels and row pixels. The power array has a plurality of power lines and ground lines, wherein each column pixel is coupled to one power line and one ground line. The decoding circuit disposed in one side of the pixel array receives and generates an address to select one or a plurality of column pixels or row pixels. The digital-to-analog (D/A) converting and driving circuit to drive the pixel array. The spare circuit array has a spare D/A converting and driving circuit, and a spare decoding circuit. The spare power line array has a plurality of spare power lines and ground lines. The fuse array can be programmed by mechanical cutting, a high energy laser beam or a high voltage. When the reading circuit, the analog-to-digital circuit, the decoding circuit, the driving circuit, the power line or the ground line coupled by the selected column pixel or row pixel fails, a repair procedure is applied to select the spare driving circuit, the spare decoding circuit, the spare reading circuit, the spare power line or the ground line to replace the fail one via the fuse array.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram of the first embodiment of a solid-state imaging device with CMOS sensor of the invention.

FIG. 2 is a block diagram of the second embodiment of the solid-state imaging device with CMOS sensor of the invention.

FIG. 3 is a block diagram of the third embodiment of the solid-state imaging device with CMOS sensor of the invention.

FIG. 4 is a block diagram of the fourth embodiment of the solid-state imaging device with CMOS sensor of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

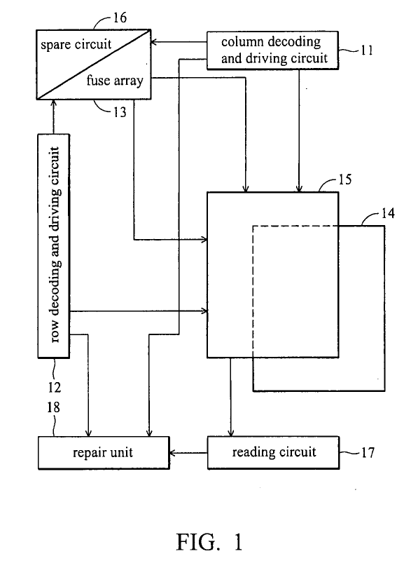

FIG. 1 is a block diagram of the first embodiment of a solid-state imaging device with CMOS sensor of the invention. In FIG. 1, CMOS sensor comprises multiple conductive line layers, wherein the pixel array 15 and the power line array 14 are disposed on different conductive line layers. The pixel array 15 has a plurality of column pixels, wherein each column pixel is coupled to one ground line and one power line in power array 14. The column decoding and driving circuit 11 receives an address to select and drive one or a plurality of column pixels of the pixel array 15. The row decoding and driving circuit 12 receives an address to select and drive one or a plurality of row pixels of the pixel array 15. The reading circuit 17 reads and outputs the data of the pixel array 15, wherein the reading circuit 17 has a plurality of reading units and each reading unit corresponds to one column pixel or row pixel. When a driving circuit, a decoding circuit, a reading circuit, a power line or a ground line coupled to a column pixel of pixel array 15 fails, the repair unit 18 select a spare driving circuit, a spare decoding circuit, a spare reading circuit, a spare power line or a spare ground line from the spare circuit 16 and processes a repair procedure to replace the fail one via a fuse array 13. In one example, the power line array 14 and a spare power line array are disposed on different layers.

During the repair procedure of replacing the fail decoding circuit, driving circuit, reading circuit, power line or ground line by the spare driving circuit, spare decoding circuit, spare reading circuit, spare power line or spare ground line from the spare circuit 16, a high energy laser beam or a high voltage is applied to isolate the failed circuit, power line or ground line. The high energy laser beam or high voltage is then applied again to make connection between the fuse array 13 and the spare driving circuit, the spare decoding circuit, the spare reading circuit, the spare power line or a the spare ground line from the spare circuit 16. In this embodiment, the fuse array comprises a metal fuse, poly fuse, polycide fuse or switch matrix circuit.

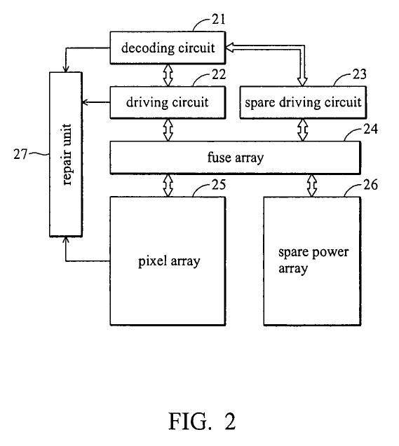

FIG. 2 is a block diagram of the second embodiment of the solid-state imaging device with CMOS sensor of the invention. The decoding circuit 21 receives an address to select one or a plurality of pixels of the pixel array 25. The driving circuit 22 has a plurality of driving units (not shown in FIG. 2), wherein each driving unit drives one or a plurality column pixels or row pixels based on the decoding result from the decoding circuit 21. The spare driving circuit 23 has a plurality of spare driving units (not shown in FIG. 2), coupled to the fuse array 24 and decoding circuit 21 to replace the fail driving unit. When one driving unit of the driving circuit 22 fails, the corresponding column pixels or row pixels cannot be driven, and the repair unit 27 processes a repair procedure to select one spare driving unit of the spare driving circuit 23 to replace the fail driving unit.

During the repair procedure of replacing the fail driving unit of the driving circuit 22 by the spare driving unit of the spare driving circuit 23, a high energy laser beam or a high voltage is applied to isolate the fail driving unit. The high energy laser beam or high voltage is then applied again to the fuse array 24 to make connection between the fuse array 24 and the spare driving unit.

Furthermore, when the power line or the ground line coupled by the selected column pixel or row pixel of pixel array 25 fails, the repair procedure is applied to the fuse array 24 and selects one spare power line or one ground line of the spare power array 26 to replace the fail one via the fuse array 24.

In this embodiment, the repair unit 27 is a built-in self test (BIST) circuit, a test module circuit or a scan chain insertion circuit. The repair unit 27 is built-in or external circuit and can be implemented by software, firmware or hardware.

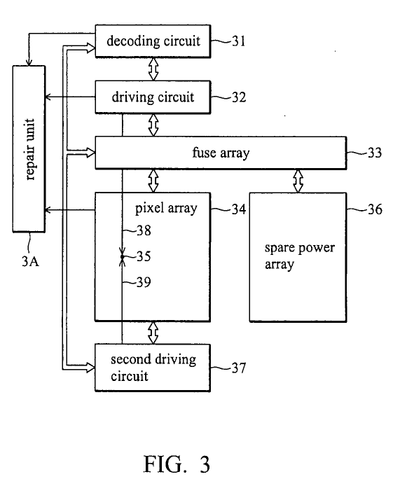

FIG. 3 is a block diagram of the third embodiment of the solid-state imaging device with CMOS sensor of the invention. The decoding circuit 31 coupled to the driving circuit 32 and the second driving circuit 37 receives an address or addresses to select one column(row) or columns(rows). The driving circuit 32 and the second driving circuit 37 then drive the selected column(s). In FIG. 3, pixel 35 is a dead pixel, arrow 38 points the driving direction of the driving circuit 32, and arrow 39 points the driving direction of the second driving circuit 37. In a conventional CMOS sensor, only the driving circuit 32 is designed, thus, when the pixel 35 is dead, the pixels after the dead pixel cannot be driven, and are regarded as dead pixels. Therefore, the second driving circuit 37 is applied and disposed in one side of the pixel array 34 opposite to the driving circuit 32 and the second driving circuit 37 is driven based on the decoding result of the decoding circuit 31 to drive the pixels after the dead pixel 35 in the direction pointed by the arrow 39, thus, the number of dead pixels can be reduced. If the number of the fail driving units exceeds the number of the spare driving units, the second driving unit can be used to repair and replace the fail driving unit by the repair unit 3A.

Furthermore, when the power line or the ground line coupled by the selected column pixel or row pixel of pixel array 34 fails, a repair procedure is applied to the fuse array 33 and selects one spare power line or one ground line of the spare power array 36 to replace the failed line via the fuse array 33.

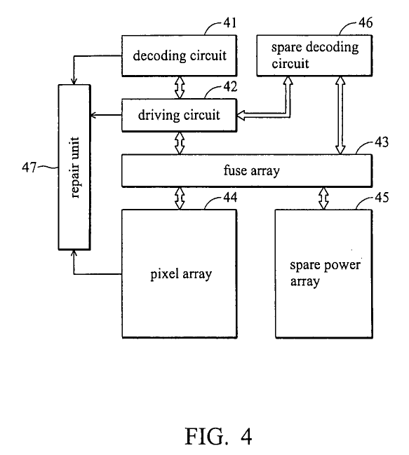

FIG. 4 is a block diagram of the fourth embodiment of the solid-state imaging device with CMOS sensor of the invention. In FIG. 4, the decoding circuit 41 has a plurality decoding units (not shown in FIG. 4), wherein each decoding unit corresponds to at least one column pixels or row pixels. The spare decoding circuit 46 has a plurality decoding units (not shown in FIG. 4) coupled to the fuse array 43 and driving circuit 42. When one decoding unit of the decoding circuit 41 fails, the repair unit 47 processes a repair procedure to select one spare decoding unit of the spare decoding circuit 46 to replace the fail decoding unit based on the address of the corresponding column pixels or row pixels.

During the repair procedure, a high energy laser beam or a high voltage is applied to isolate the fail decoding unit. The high energy laser beam or high voltage is then applied again to the fuse array 43 to make connection between the spare decoding unit and the column pixels originally coupled to the failed decoding unit. In another embodiment, the fuse array is made up of metal fuses and can be cut mechanically to isolate the failed element, such as a driving unit or decoding unit, and the column pixels or row pixels.

Furthermore, when one or a plurality of power lines or the ground lines coupled by the selected column pixel or row pixel of pixel array 44 fail, one or a plurality of spare power lines or ground lines of the spare power array 45 are selected by the repair unit 47 to replace the failed power lines or ground lines via the fuse array 43.

Although the described embodiments are illustrated with CMOS sensor, the described repair mechanism and architecture also can be employed in the liquid crystal display, plasma display, CCD sensor or any electronic device with pixel array.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A solid-state image sensor, comprising:
a pixel array having a plurality of column pixels and row pixels;
a reading circuit having a plurality of reading unit;
an analog-to-digital (A/D) circuit having one or a plurality of A/D converters;
a decoding circuit disposed in one side of the pixel array, receiving or generating an address to select one or a plurality of column pixels or row pixels;
a driving circuit having a plurality of driving unit to drive the selected column pixels or row pixels;
a power array having a plurality of power lines and ground lines, wherein each column pixel is coupled to one power line and one ground line;
a spare circuit having a spare driving circuit, a spare decoding circuit, a spare reading circuit, a plurality of spare power lines and ground lines;
a fuse array;
a repair unit; and
when the decoding circuit, the driving circuit, the reading circuit, the power line or the ground line coupled to the selected column pixel or row pixel fail, a repair procedure is applied to select the spare driving circuit, the spare decoding circuit, the spare reading circuit, the spare power line or the spare ground line to replace the failed one via the fuse array.

2. The sensor as claimed in claim 1, wherein when the decoding circuit fails, the repair procedure is applied to select the spare decoding circuit to replace the failed decoding circuit via the fuse array.

3. The sensor as claimed in claim 1, further comprising a second driving circuit disposed in another side of the pixel array opposite the driving circuit.

4. The sensor as claimed in claim 1, wherein the decoding circuit comprises a plurality of decoding unit and each decoding unit corresponds to one column pixels.

5. The sensor as claimed in claim 4, wherein the spare decoding circuit comprises a plurality of spare decoding unit to replace the fail decoding unit via the fuse array.

6. The sensor as claimed in claim 1, wherein the fuse array is made up of metal fuse, poly fuse, polycide fuse or switch matrix circuit.

7. The sensor as claimed in claim 1, wherein the repair unit is a built-in self test (BIST) circuit.

8. The sensor as claimed in claim 1, wherein the repair unit is a scan chain insertion circuit.

9. The sensor as claimed in claim 1, wherein the repair procedure comprises:
isolating the failed decoding circuit, driving circuit, reading circuit, power line or ground line by a high energy laser beam or high voltage; and
applying the high energy laser beam or high voltage to the fuse array to make connections between the fuse array and the spare driving circuit, the spare decoding circuit, the spare reading circuit, the spare power line or the ground line.

10. The sensor as claimed in claim 1, wherein the driving circuit comprises a plurality of driving unit and each driving unit drives to one corresponding column of pixels.

11. The sensor as claimed in claim 10, further comprising a spare driving circuit comprising a plurality of spare driving units, wherein when one driving unit fails, one of the spare driving units replaces the failed driving unit via the fuse array.

12. The sensor as claimed in claim 1, wherein when the reading circuit fails, the repair procedure is applied to select the spare reading circuit to replace the failed circuit via the fuse array.

13. The sensor as claimed in claim 1, wherein the reading circuit comprises a plurality of reading unit and each reading unit corresponds to one column of pixels.

14. The sensor as claimed in claim 1, wherein the spare reading circuit comprises a plurality of spare reading unit to replace the fail reading unit via the fuse array.

15. The sensor as claimed in claim 1, wherein the solid-state image sensor is formed by CMOS, CCD, amorphous silicon or III-V compound semiconductor by integrated circuit process.

16. The sensor as claimed in claim 1, further comprising a signal chip device having data I/O, digital signal processing function, and memory.

17. The sensor as claimed in claim 1, wherein the solid-state image sensor can be employed in electronic devices driven or read by digital or analog mechanisms.

18. An image display device, comprising:
a pixel array having a plurality of column pixels and row pixels;
a power array having a plurality of power lines and ground lines, wherein each column pixel is coupled to one power line and one ground line;
a decoding circuit disposed in one side of the pixel array, receiving or generating an address to select one or a plurality of column pixels or row pixels;
a digital-to-analog (D/A) converting and driving circuit to drive the pixel array;
a spare circuit array having a spare D/A converting and driving circuit, and a spare decoding circuit,
a spare power line array having a plurality of spare power lines and ground lines;
a fuse array programmed by mechanical cutting, a high energy laser beam or a high voltage;
a repair unit; and
when the decoding circuit, the D/A converting and driving circuit, the power line or the ground line coupled by the selected column pixel or row pixel fail, a repair procedure is applied to select the decoding circuit, the D/A converting and driving circuit, the spare power line or the ground line to replace the failed line via the fuse array.

19. The device as claimed in claim 18, wherein the image display device comprises a liquid crystal display panel, a plasma display panel, an organic light emitting display, or any electronic device comprising a pixel array.

20. The device as claimed in claim 18, wherein the image display device comprises electronic devices driven and shown by digital or analog mechanism.

21. The device as claimed in claim 18, wherein the repair procedure comprises:
isolating the failed decoding circuit, driving circuit, reading circuit, power line or ground line by a high energy laser beam, a high voltage or mechanical cutting; and
making connections between the fuse array and the spare driving circuit, the spare decoding circuit, the spare reading circuit, the spare power line or the ground line.

22. The device as claimed in claim 18, wherein the repair unit is a built-in self test (BIST) circuit.

23. The device as claimed in claim 18, wherein the repair unit is a test module circuit.
